(19) United States
(12) Patent Application Publication
(10) Pub. No.: US 2013/0313394 A1
(43) Pub. Date: Nov. 28, 2013

(54) DEVICE FOR STABILIZING A BOOM ARM MICROPHONE STAND

(71) Applicant: Harlan Robert Hogan, North Barrington, IL (US)

(72) Inventor: Harlan Robert Hogan, North Barrington, IL (US)

(21) Appl. No.: 13/902,049

(22) Filed: May 24, 2013

Related U.S. Application Data
(60) Provisional application No. 61/651,420, filed on May 24, 2012.

(51) Int. Cl. F16M 13/00

(52) U.S. Cl. CPC F16M 13/00
USPC 248/499

(57) ABSTRACT

A retaining device is provided for maintaining the position of a microphone mounted to a boom arm with the boom arm being pivotally mounted to a microphone stand. The retaining device is a strap assembly that can include upper and lower securing portions of the strap assembly for being secured to the boom arm and the microphone stand, respectively, and a middle portion of the strap assembly interconnecting the upper and lower securing portions and including an adjustment mechanism for adjusting tension between the upper and lower securing portions.

### CROSS REFERENCE TO RELATED APPLICATION

This patent application claims benefit under 35 U.S.C. §119 (e) to United States Provisional Application No. 61/651,420 entitled “Device for Stabilizing a Boom Arm Microphone Stand” filed May 24, 2012, having attorney docket number 9363-100905-US, the contents of which are incorporated herein by reference in its entirety.

### FIELD OF THE INVENTION

The invention relates to a device for stabilizing a boom mounted microphone and microphone stand.

### BACKGROUND OF THE INVENTION

Boom arm microphone stands, which support a microphone attached to a long pole, or arm, are well-known in the art. During operation of the microphone, an operator can either hold the boom microphone arm or use a stand to support the boom arm. If a stand is used to support the boom arm, it is desirable that the microphone remain in the position chosen by a user.

A microphone stand for supporting a boom arm most often features a tripod-type base. The legs of the tripod form a very small angle with respect to the ground, so that the legs are almost horizontal. Alternatively, the stand can have a solid base in a variety of shapes. A vertical pole rises from the tripod or base, and the boom arm connects with this vertical pole. Often, for the purpose of connecting with the boom arm, the vertical pole has a threaded top, upwardly projecting shank portion. In this case, the boom arm carries a clamp portion for being clamped on to a threaded adapter portion which, in turn, is threaded to the threaded upward projecting shank portion of the vertical pole of the microphone stand. Regardless of how the boom arm connects to the stand, the vertical pole forms a fulcrum about which the boom arm pivots. By pivoting the boom arm, a user can raise or lower the microphone to a desired position.

Once the boom arm is at a user's preferred angle and, thus, the microphone is in a desired position, pivoting of the arm with respect to the stand is no longer desirable, since it is uncontrolled pivoting of the boom arm that can cause the microphone to fall to the ground. In order to fix the microphone against falling to the ground, the clamp portion includes a yoke with two legs extending downwards from the boom arm. The threaded adapter of the boom arm includes an upper head portion sized to fit between the yoke legs and a depending threaded portion that includes internal threads for receiving the threaded shank portion of the microphone stand. A clamp handle or knob is used to turn a screw device for clamping and unclamping of the yoke legs relative to the adapter head portion therebetween. When the clamp is loosened, the boom arm is able to pivot via pivoting of the yoke legs about a screw shaft of the clamp screw device. When the boom arm is pivoted to the desired orientation, the handle is turned to cause the yoke legs to shift towards each other for clamping the yoke legs against the adapter head portion to keep the yoke legs and boom arm from further pivoting about the screw shaft.

However, a friction clamp is susceptible to being overcome by the weight of the microphone. Vibrations that occur during recording can contribute forces that cause a frictional clamp to gradually loosen to the point of failure, where the microphone will drop down and hit the ground, sustaining damage. Furthermore, an operator may easily fail to sufficiently tighten the clamp, putting the microphone at risk of falling to the ground. Moreover, over time, the clamping mechanism may wear, diminishing its ability to protect the microphone from falling. Despite the presence of a clamping mechanism, the microphone may still fall to the ground, sustaining damage.

As an additional protective measure, the boom arm often includes a counterweight opposite the microphone. Theoretically, this counterweight balances the weight of the microphone on the other end of the arm. The counterweight would thus serve to decrease the loosening force on a frictional clamping mechanism. Nevertheless, once the clamp fails or is not tightened sufficiently, the boom arm will freely pivot. The microphone is typically weighted sufficiently so that, if the boom arm freely pivots, the microphone will still fall toward the ground.

### SUMMARY OF THE INVENTION

In accordance with one aspect of the present invention, a retaining device is provided that is adapted to provide a connector between a boom arm and the microphone stand to which the boom arm is pivotably connected. The device adds additional stability to the boom arm and decreases the risk of the microphone falling to the ground. In one form, the retaining device can be considered a tensioning device. In this form, the tension device is configured to attach to a microphone stand and the end portion of a boom arm opposite the microphone. Because the retaining device and the microphone are on opposite sides of the pivot connector, when the retaining device is operable to provide an interconnection and tension between the boom arm and the microphone stand, the tension in the device restricts downward motion of the microphone.

Preferably, the retaining device is a strap assembly, including flexible strap members made of polyester webbing or another suitable material, which has an upper end securing portion, a lower end securing portion, and a middle portion that connects the upper end portion and the lower end portion. The upper securing end portion is configured to be attachable to the end portion of the boom arm, and the lower end securing portion is configured to be attachable to the microphone stand. The middle portion has an adjustment mechanism that is configured so that the length of the retaining device is adjustable.

In a preferred form, the lower end portion of the device includes a strap of nylon webbing. The strap of webbing may be wrapped around the vertical pole or tripod of the microphone stand for attaching the lower end portion of the retaining device to the microphone stand. The lower end portion also includes non-skid material on either one or both sides of the webbing strap. Preferably, the non-skid material is made of rubber, latex, Styrene-butadiene, or lycra or another polymer material. The non-skid material may be attached to the webbing by sewing, gluing, heat transfer, or during the weaving process.

When the webbing strap is wrapped around the microphone stand, the non-skid material faces inward, toward the stand to be in engagement therewith, minimizing translation of the lower end portion of the device along the stand. The lower end portion also features hook-and-loop fasteners for securing the lower end portion when it is wrapped around the stand.

The upper end portion of the retaining device preferably includes a pad made of nylon or another suitable material, and the upper end portion of the device is configured to be attachable to the end portion of the boom arm. The pad is preferably substantially oblong shaped and may be folded around the boom arm in engagement therewith. The upper end portion of the device may additionally include non-skid material on at least one side of the pad to avoid translation of the pad along the arm. Preferably, the non-skid material is made of rubber, latex, styrene-butadiene, Lycra or another polymer material. The non-skid material may be attached to the webbing by sewing, gluing, heat transfer, or during the weaving process. The upper end portion of the device also includes a mechanism for securing the upper end portion of the device to the boom arm. In a preferred form, the upper end portion of the device includes at least one strap of nylon webbing for wrapping around the boom arm in order to secure the upper end portion to the boom arm. Releasable connectors or fasteners such as hook-and-loop fasteners on one or both sides of the straps are used to fasten the straps in place so that the upper end portion of the retaining device is attached to the boom arm.

In one form, so that the tension of the retaining device is adjustable, the length of the device is adjustable. A slide or another similar mechanism located on the middle portion of the device facilitates adjustment of the length and, thus, the tension of the device. Because the length the retaining device is adjustable, the device is operable to secure the boom arm when it is at a variety of angles. For example, if the boom arm is positioned horizontally, the device can be adjusted to a first length in order to achieve proper tension in the device. If, on the other hand, the boom arm is positioned at an angle so that the microphone is higher than it would be when the boom arm is positioned horizontally, the device can be shortened so as to achieve proper tension for this other boom arm position.

Additionally, features of the device facilitate re-positioning the microphone in a preferred position when the boom arm must be disassembled from the stand between uses or otherwise repositioned from a preferred arrangement. Specifically, a mark placed on the middle portion of the device below the slide or similar mechanism when the device is adjusted so that it is taut indicates the length of the strap when the microphone was at the preferred position. By adjusting the device so that the mark is again below the slide and positioning the boom arm so that the retaining device is taut, a user can recreate the preferred microphone position.

### BRIEF DESCRIPTION OF THE DRAWINGS

FIG. 1 is a plan view of the retaining device;

FIG. 2 is a perspective view of the retaining device secured to the microphone stand and boom arm;

FIG. 3 is an enlarged plan view of the front of the lower end portion of the retaining device, showing the configuration of the non-skid material and the hook-and-loop material;

FIG. 4 is an enlarged plan view of the back of the lower end portion of the retaining device, showing the configuration of the hook-and-loop material;

FIG. 5 is an enlarged perspective view showing the loophole formed when the end of the lower end portion of the retaining device is passed through the loop;

FIG. 6 is an enlarged perspective view showing the lower portion of the retaining device wrapped around the microphone stand and illustrating the hook and loop fasteners;

FIG. 7 is an enlarged plan view of the front of the upper end portion of the retaining device, showing the arrangement of the pad, the nylon material, the straps of webbing, and the hook-and-loop material;

FIG. 8 is an enlarged plan view of the back of the upper end portion of the retaining device, showing the non-skid material attached to the pad;

FIG. 9 is an enlarged elevation view showing the upper end portion of the retaining device in the process or being secured to the boom arm and illustrating the hook and loop fasteners; and

FIG. 10 is an enlarged perspective view showing how a mark can be placed on the middle portion of the retaining device for use when repositioning the device.

### DETAILED DESCRIPTION OF THE PREFERRED EMBODIMENTS

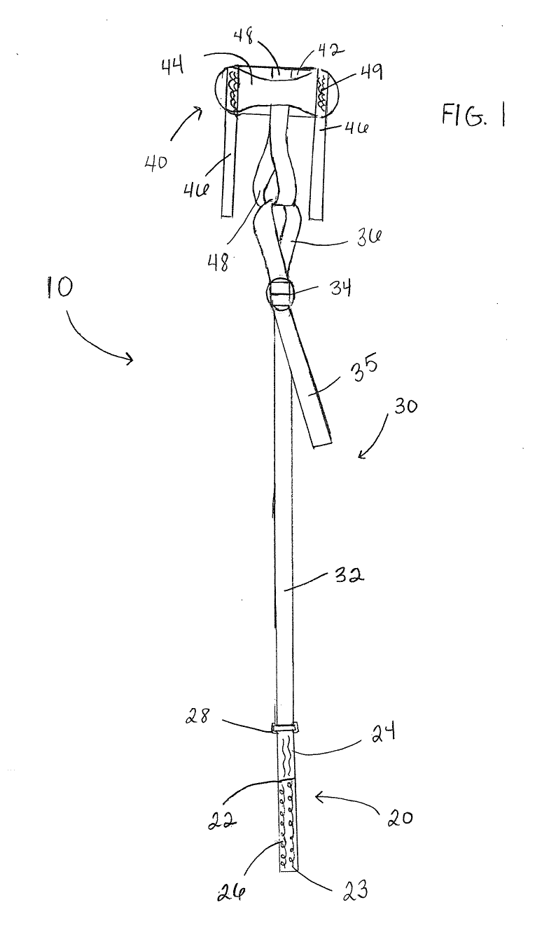

In FIGS. 1-10, a retaining device 10 in accordance with the present invention is illustrated. The retaining device 10 is a strap assembly, which includes a lower end securing portion 20 for attaching to a microphone stand 100 and an upper end securing portion 40 for attaching to a boom arm 102. The middle portion 30 of the retaining device 10 connects the upper end portion 40 and the lower end portion 20 and features a mechanism such as a slide 34 for adjusting the length of the device 10 in order to achieve appropriate tension so that the device stabilizes the boom arm 102.

The lower end portion 20 of the retaining device 10 is configured to attach to the microphone stand 100, such as to one of the legs 104 of the tripod-type base 106 thereof or to the vertical pole 107 itself In accordance with a preferred form of the invention, the lower end portion 20 of the device 10 wraps around the microphone stand 100 and is secured with a releasable connector or fastener such as hook-and-loop fasteners 26. Preferably, the lower end portion 20 of the retaining device 10 includes a strap of nylon webbing material 22 that is attached to the rest of the retaining device 10 by a loop 28, which is made of plastic or another suitable material. One side of the webbing strap 22 includes the loop component of the hook-and-loop fastener 26, and the other side of the strap 22 includes the hook component. One or both sides the strap 22 feature non-skid material 24.

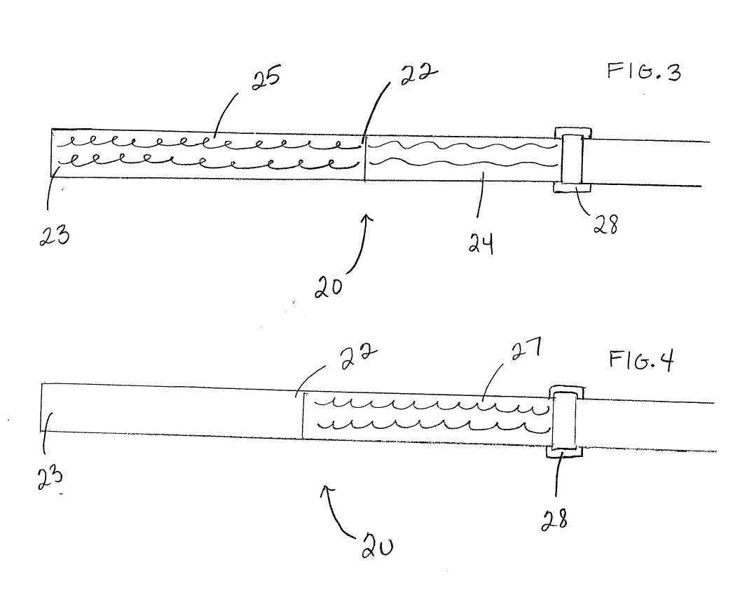

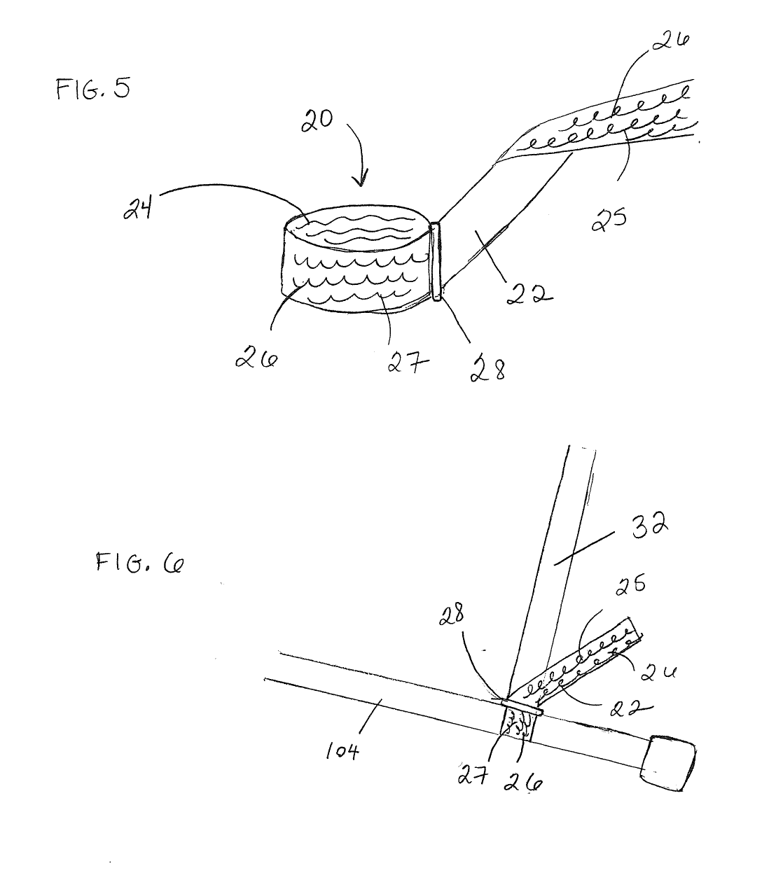

Considering the arrangement of the non-skid material 24 and hook-and-loop material 26 on the webbing strap 22, an exemplary, and not limiting, arrangement could be as follows. As shown in FIG. 3, on one side, the webbing strap 22 includes a strap of non-skid material 24, which extends from the loop 28 about halfway to the end 23 of the webbing 22. On the same side of the webbing 22, a strap of loop material 25 extends from the end of the non-skid material 24 to the end 23 of the webbing strap 22. As shown in FIG. 4, on the opposite side of the webbing 22, a strap of hook material 27 extends from the loop 28 about halfway to the end 23 of the webbing strap 22.

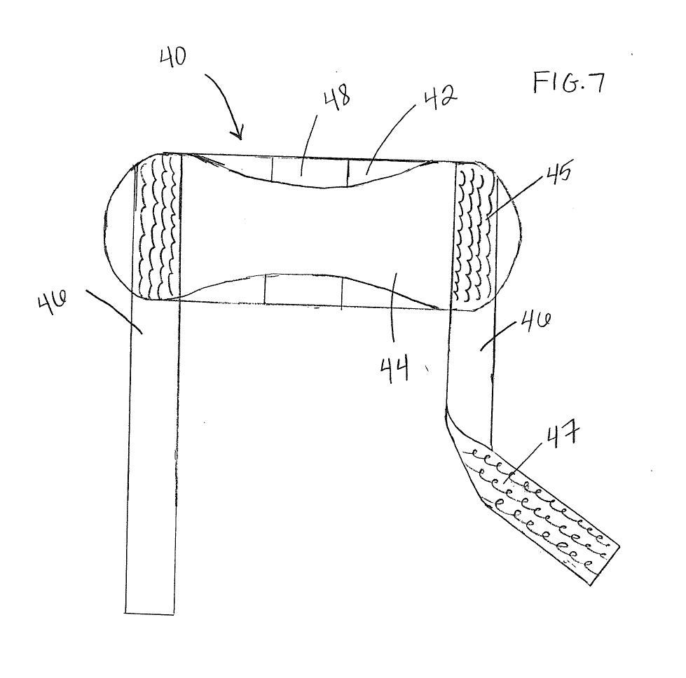

As shown in FIGS. 5 and 6, in order to secure the lower end portion 20 of the device 10 to the microphone stand 100, the end 23 of the nylon webbing strap 22 is passed through the loop 28 so that the strap of webbing 22 forms a loophole around the microphone stand leg 104. The non-skid material 24 is on the inner surface of the loophole, and the hook-and-loop material 26 is on the outer surface of the loophole. When the end 23 of the webbing 22 is pulled, the loophole formed by the lower end portion 20 of the strap 22 is reduced in size to tighten around the microphone stand leg 104. When the lower end portion 20 of the device 10 is tightened around the stand leg 104, the non-skid material 24 faces inward, in engagement with the stand leg 104. On the portion of the lower end portion 20 of the device 10 that is wrapped around the stand leg 104, the hook-and-loop material 26 faces outward. Preferably, the hook component 27 of the hook and loop material 26 faces outward after the lower end portion 20 of the device 10 is wrapped around the microphone stand. The mating portion of the hook-and-loop fastener 26 is on the tail of webbing strap 22 that has been passed through the loop 28. Preferably, the loop component 25 of the hook and loop material 26 is on the tail of the webbing strap 22. Thus, the tail may be folded as shown in FIG. 5 so that the loop component 25 can be pressed to the hook component 27 which faces outward on the portion of the lower end portion 20 of the device 10 that has been wrapped around the stand leg 104, engaging the hook-and-loop material and securing the lower end portion of the device to the stand leg 104.

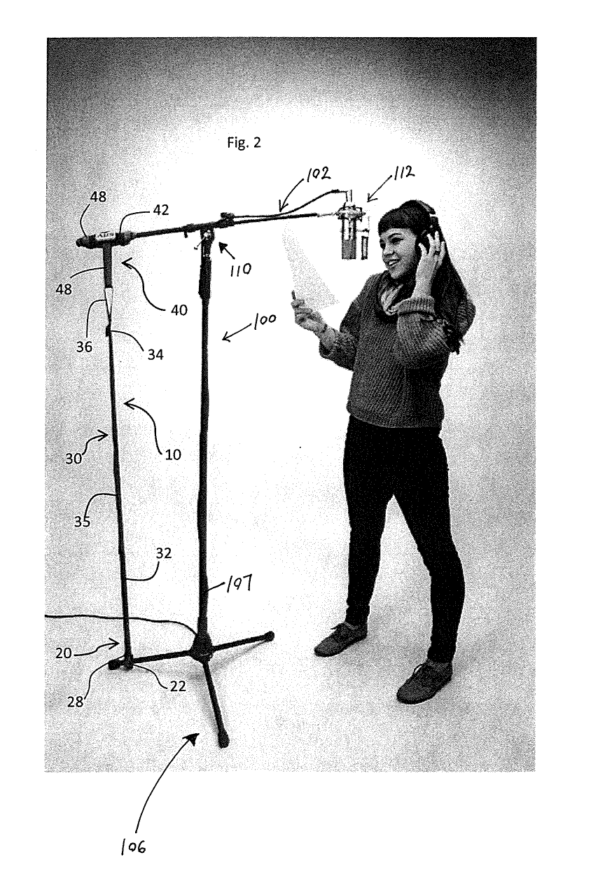

As shown in FIGS. 1 and 2, the middle portion 30 of the retaining device 10 connects the lower portion 20 and the upper portion 40. In one form, the middle portion includes a strap of nylon webbing 32 attached at its lower end to the plastic or metal loop 28. The middle portion 30 includes a mechanism for adjusting the length of the retaining device 10. Preferably, the middle portion 30 includes a slide 34 for adjusting the length of the retaining device. In a preferred form, the upper end of the nylon webbing strap 32 passes through one end of the slide 34, made of plastic, metal, or another suitable material, such that the end 35 of the strap 32 may be pulled to shorten the retaining device 10. The slide 34 also facilitates joining the upper end 40 portion of the retaining device 10 with the middle portion 30 of the device 10. In one form, another segment 36 of webbing attaches to the other end of the slide 34. In a preferred form, the segment 36 forms a loop, and another loop 48 passes through the loop formed by the segment 36. Loop 48 passes through the width of the pad 42 at the upper end portion of the device 10.

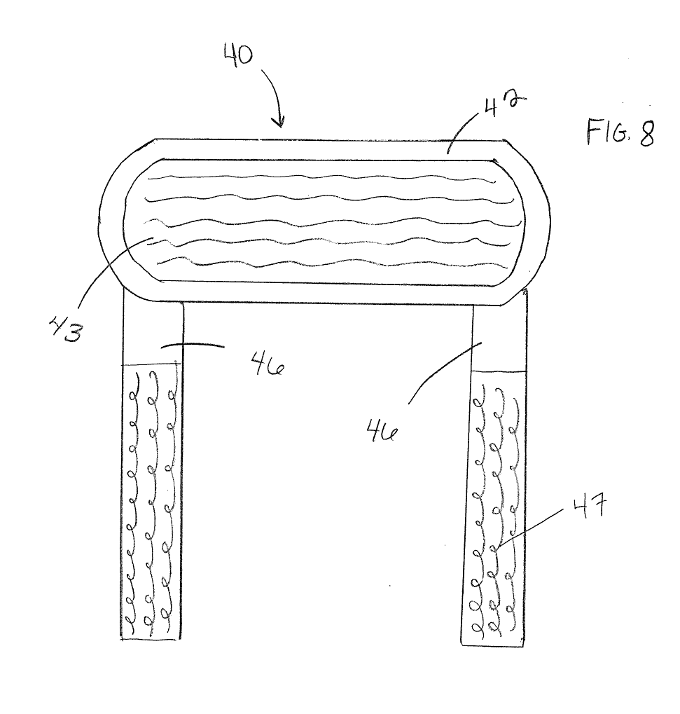

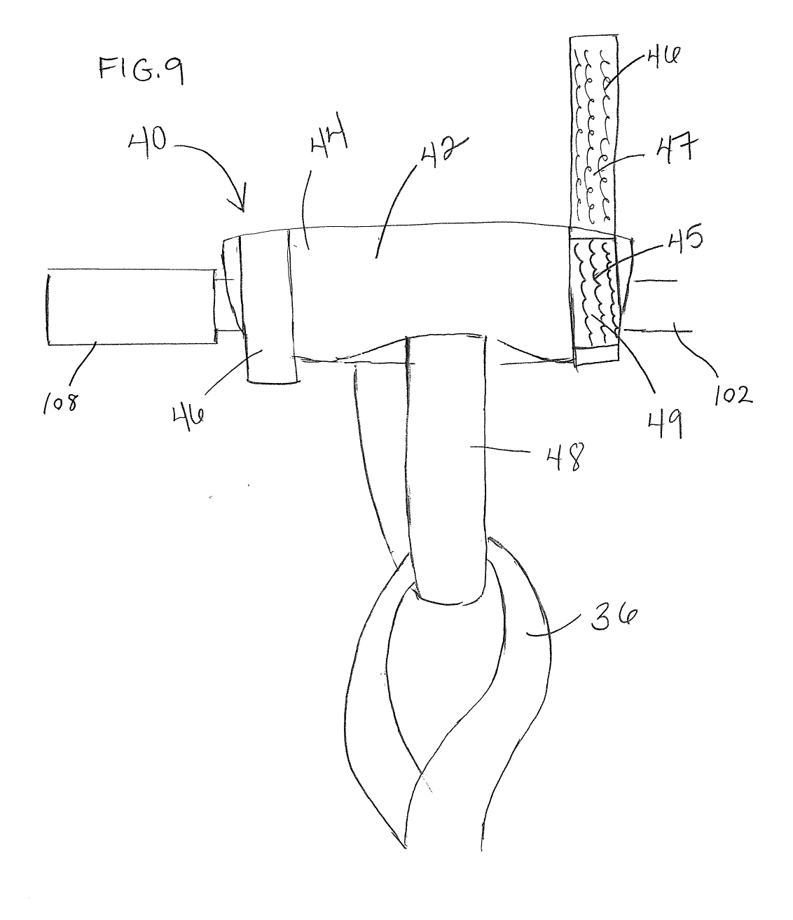

Turning to FIGS. 7 and 8, the upper end portion 40 of the retaining device 10 is illustrated. The upper end portion is operable to attach to a boom arm 102, such as between counterweight 108 at one end thereof and friction clamp 110 at a central portion thereof where the boom arm 102 is pivotally connected to vertical pole 107 of the microphone stand 100. In a preferred form, the upper end portion 40 includes a pad 42. In a preferred form, the pad 42 is an oblong shape with rounded ends and is constructed of a nylon material. On one or both sides of the pad 42, non-skid material 43 such as a resilient or elastomeric material is present. In a preferred form, only one side of the pad 42 includes the non-skid material 43.

As shown, a piece of nylon or other material 44 is attached to the pad 42. The nylon piece 44 has a substantially similar shape to the pad 42, and is connected at its ends to the pad 42. Because the nylon piece 44 is not connected to the rest of the pad 42 at its center, a strap of webbing formed into loop 48 can pass between the nylon piece 44 and the rest of the pad 42, serving to connect the upper end portion 40 of the retaining device 10 to the middle portion 30 of the device 10 and, by proxy, the lower end portion 20 of the device 10.

In one form, at least one strap of nylon webbing material 46 is attached to the pad 42. For example, the strap 46 could be sewn or otherwise attached to the pad 42 so that one end of the strap 46 extends across the width of the pad 42. A releasable connector or fastener such as formed from hook-and-loop material is attached to each strap 46. In a preferred form, one side of the strap features the hook component of the hook-and-loop fastener 49 and the other side of the strap features the loop component.

In a further preferred form, two webbing straps 46 are attached to the nylon piece 44 at either end of the pad 42. The straps are fastened to the nylon piece 44 so that they extend across the width of the pad 42. The hook portion 45 of the hook-and-loop fastener 49 is attached to the portion of each strap 46 that extends across the pad 42 so that the hooks 45 are on the top portion of the pad 42. On the opposite side of each strap 46, the loop portion 47 of the hook-and-loop fastener extends from the end of the strap 46 toward the point where the strap 46 connects to the pad 42.

As shown in FIG. 9, in order to secure the upper portion 40 of the device 10 to the boom arm 102, the boom arm 102 is fed through loop 48. The pad 42 is then placed against the boom arm so that the side of pad 42 with the non-skid material 43 faces the boom arm. The pad 42 is then folded lengthwise around the boom arm 102. Each strap 46 is wrapped around the boom arm and the folded pad 42. The strap 46 is then pressed down against the top of the pad 42 so that hook and loop material 49 on the top of the pad engages with the hook and loop material 49 on the underside of the strap 46 and the non-skid material 43 tightly engages the boom arm 102 to minimize any relative motion therebetween.

Once the lower end portion 20 and the upper end portion 40 of the retaining device 10 are attached to the microphone stand leg 104 and boom arm 102, respectively, the retaining device 10 is adjusted to be taut so that the tension in the device 10 minimizes motion of the boom arm 102 and microphone 112 mounted to the end thereof Thus, in the boom arm retention configuration of the device 10, each of strap members 22, 32, and 48 are generally taut. If, with the retaining device 10 attached to the boom arm 102 and the microphone stand 100, the portion of the boom arm 102 extending from the friction clamp 110 to the microphone 112 cannot be sufficiently lowered to a desired position, the strap of webbing 32 of the middle portion of the device 30 may be adjusted in conjunction with slide 34 so that the strap retention device 10 is lengthened. If the boom arm 102 is in the desired position, and the straps instead remains slack, the end 35 of the webbing strap 32 may be pulled so that the tension in the device 10 is increased until the device 10 is taut as it extends between the lower and upper securing portions 20 and 40 thereof

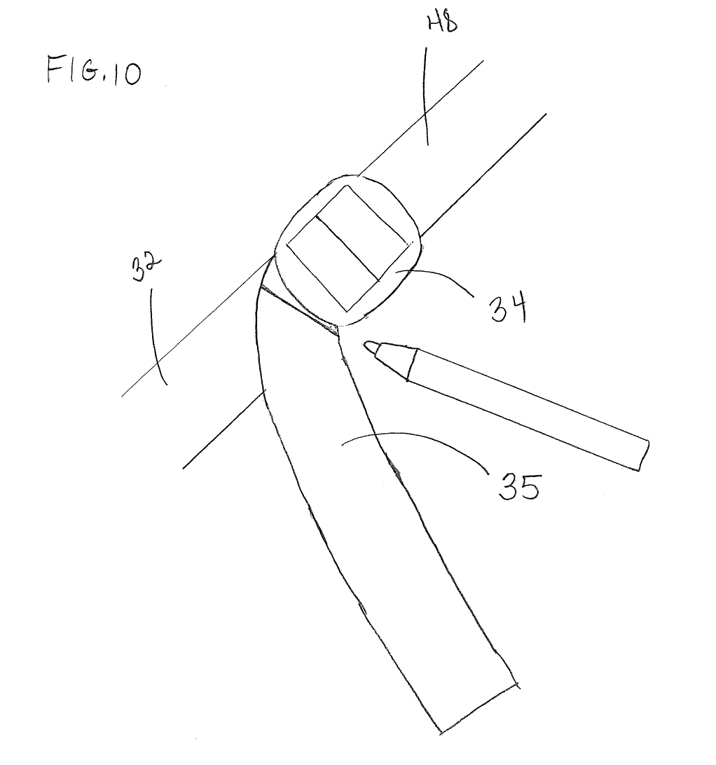

A further feature of the device 10 permits recreation of a preferred boom arm position if the arm 102 must be moved or if the boom arm 102 must be disassembled from the microphone stand 100. As shown in FIG. 10, in one form, the nylon webbing of the strap 32 is of a suitably light color so that a marker, pen, or other implement can be used to make a mark on the strap 32 immediately below the slide 34. When the preferred position of a boom arm 102 is to be recreated, the device 10 can be attached to the stand 100 and the boom arm 102. By adjusting the boom arm placement and tension in the device 10, a position can be achieved in which the mark on the strap 32 is once again immediately below slide 34. If the mark is immediately below slide 34, but the strap 32 is slack, the portion of the boom arm 102 extending from the friction clamp 110 and including the microphone 112 mounted thereto should be pivoted to be lowered until the strap 32 is taut. Once the mark is below the slide 34 and the strap 32 is taut, the preferred position of the boom arm 102 has been recreated.

While there have been illustrated and described particular embodiments of the present invention, it will be appreciated that numerous changes and modifications will occur to those skilled in the art, and it is intended in the appended claims to cover all those changes and modifications which fall within the true spirit and scope of the present invention.

1. A retaining device for a boom arm microphone stand, the retaining device comprising:
a strap assembly;
an upper securing portion of the strap assembly configured for being secured to a boom arm;
a lower securing portion of the strap assembly configured for being secured to a microphone stand; and
a middle portion of the strap assembly that connects the upper and lower securing portions and includes an adjustment mechanism for adjusting tension between the upper and lower portions for keeping the boom arm at a desired position relative to the microphone stand.

2. The retaining device of claim 1 wherein the upper securing portion includes a pad for engaging the boom arm.

3. The retaining device of claim 2 wherein the paid has non-skid material for engaging the boom arm.

4. The retaining device of claim 1 wherein the upper and lower securing portions each include a strap member having a releasable connector for releasably securing the upper and lower securing portions to the boom arm and the microphone stand.

5. The retaining device of claim 1 wherein the upper securing portion includes an elongate, foldable pad and at least one strap member for wrapping about the pad folded lengthwise about the boom arm to secure the pad thereto.

6. The retaining device of claim 1 wherein the middle portion includes a strap member that extends between the upper and lower securing portions and the adjustment mechanism includes a slide through which the strap member extends so that an end thereof can be pulled to reduce spacing between the upper and lower securing portions.
